(19) United States
(12) Patent Application Publication
(10) Pub. No.: US 2025/0160267 A1
(43) Pub. Date: May 22, 2025

(54) Mushroom Growing System and Methods of Manufacturing and Use Thereof

(71) Applicant: Daniel Rislov, Sioux Falls, SD (US)

(72) Inventor: Daniel Rislov, Sioux Falls, SD (US)

(21) Appl. No.: 18/909,395

(22) Filed: Oct. 8, 2024

Related U.S. Application Data
(60) Provisional application No. 63/601,055, filed on Nov. 20, 2023.

(51) Int. Cl. A01G 18/64; A01G 18/10; A01G 18/20

(52) U.S. Cl. CPC A01G 18/64; A01G 18/10; A01G 18/20

(57) ABSTRACT

A mushroom growing system for growing a mushroom from a gourd includes a gourd having an inner surface and an outer surface and defining an interior space. The gourd has a growth aperture extending therethrough. Mycelium are dispersed within a growth medium, which is positioned in the interior space. Pinning of the mycelium causes a mushroom to protrude from the gourd through the growth aperture enabling cropping of the mushroom.

### CROSS-REFERENCE TO RELATED APPLICATIONS

I hereby claim the benefit under 35 U.S.C. Section 119 (e) of U.S. Provisional application 63/601,055 filed Nov. 20, 2023.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to growing kits and more particularly pertains to a new growing kit for growing a mushroom from a gourd. Mushroom growing kits typically comprise plastic bags or cardboard boxes and lack aesthetic appeal.

### (2) Description of Related Art including information disclosed under 37 CFR 1.97 and 1.98.

The prior art relates to growing kits for mushrooms but which do not comprise a gourd containing a growth medium and mycelium and having one or more growth apertures through which a mushroom can grow.

### BRIEF SUMMARY OF THE INVENTION

An embodiment of the disclosure meets the needs presented above by generally comprising a gourd having an inner surface and an outer surface and defining an interior space. The gourd has a growth aperture extending therethrough. Mycelium are dispersed within a growth medium, which is positioned in the interior space. Pinning of the mycelium causes a mushroom to protrude from the gourd through the growth aperture enabling cropping of the mushroom.

Another embodiment of the disclosure includes method of manufacturing a mushroom growing system, which entails providing a gourd and a growth medium having mycelium dispersed therewithin. Steps of the method include washing and sanitizing the outer surface of the gourd, removing a section of the gourd, removing innards of the gourd, adding the growth medium to the interior space, reattaching the section to the gourd, and creating a growth aperture in the gourd.

Yet another embodiment of the disclosure includes a method of growing a mushroom, which entails provision of a mushroom growing system, as per the disclosure above. Steps of the growing method include positioning the gourd in an environment having a moderate temperature, no direct sunlight, and no breeze, pinning of the mycelium such that a mushroom protrudes from the gourd through the growth aperture, misting the mushroom as may be required depending on relative humidity, cropping the mushroom after one to two weeks, and repeating the misting and cropping steps until the growth medium has been depleted

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a mushroom growing system according to an embodiment of the disclosure.

FIG. 2 is an isometric perspective view of an embodiment of the disclosure.

FIG. 3 is an isometric perspective view of an embodiment of the disclosure.

FIG. 4 is an in-use view of an embodiment of the disclosure.

FIG. 5 is an in-use view of an embodiment of the disclosure.

FIG. 6 is an in-use view of an embodiment of the disclosure.

FIG. 7 is an in-use view of an embodiment of the disclosure.

FIG. 8 is an in-use view of an embodiment of the disclosure.

FIG. 9 is a cross-sectional view of an embodiment of the disclosure.

FIG. 10 is a flow diagram for a method of manufacturing an embodiment of the disclosure.

FIG. 11 is a flow diagram for a mushroom growing method utilizing an embodiment of the disclosure.

### DETAILED DESCRIPTION OF THE INVENTION

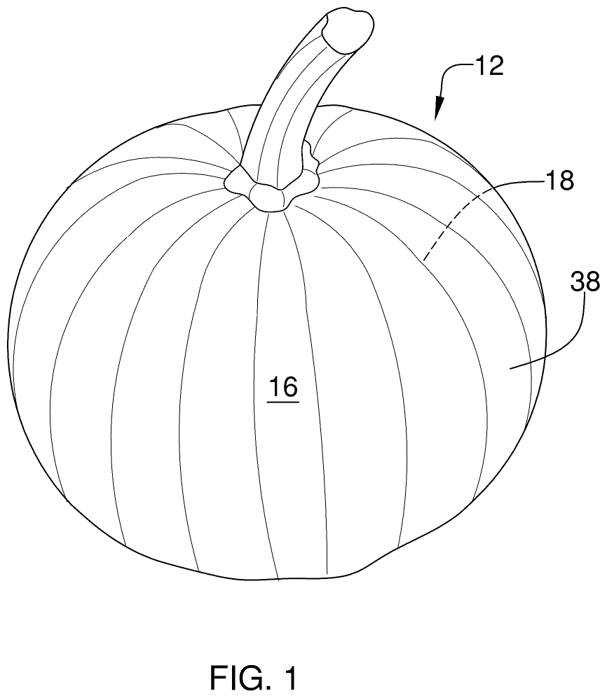

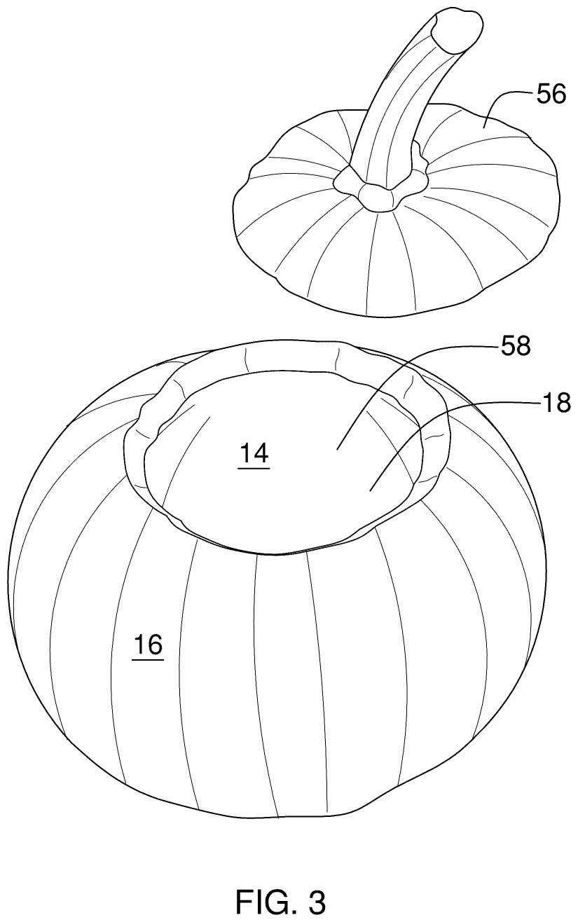

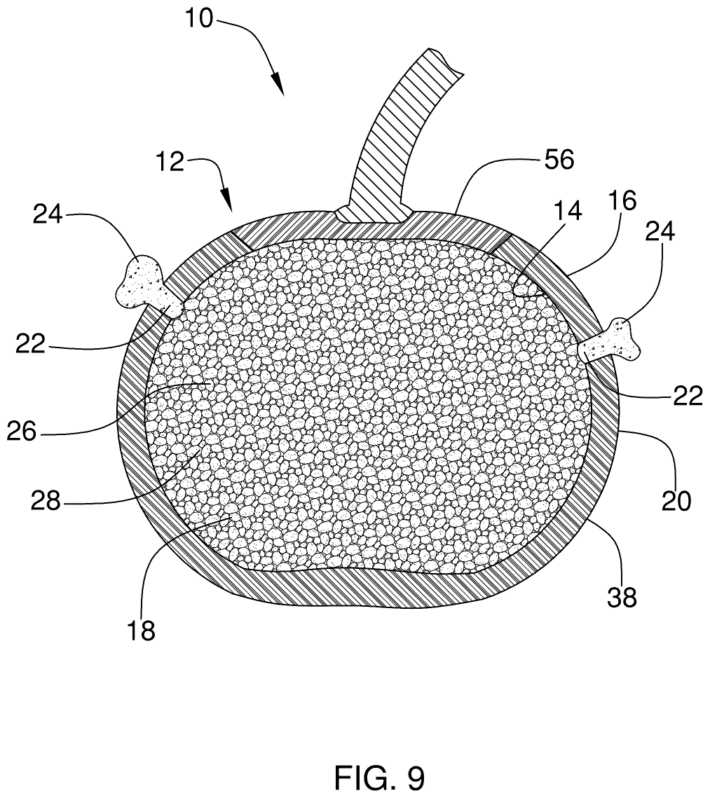

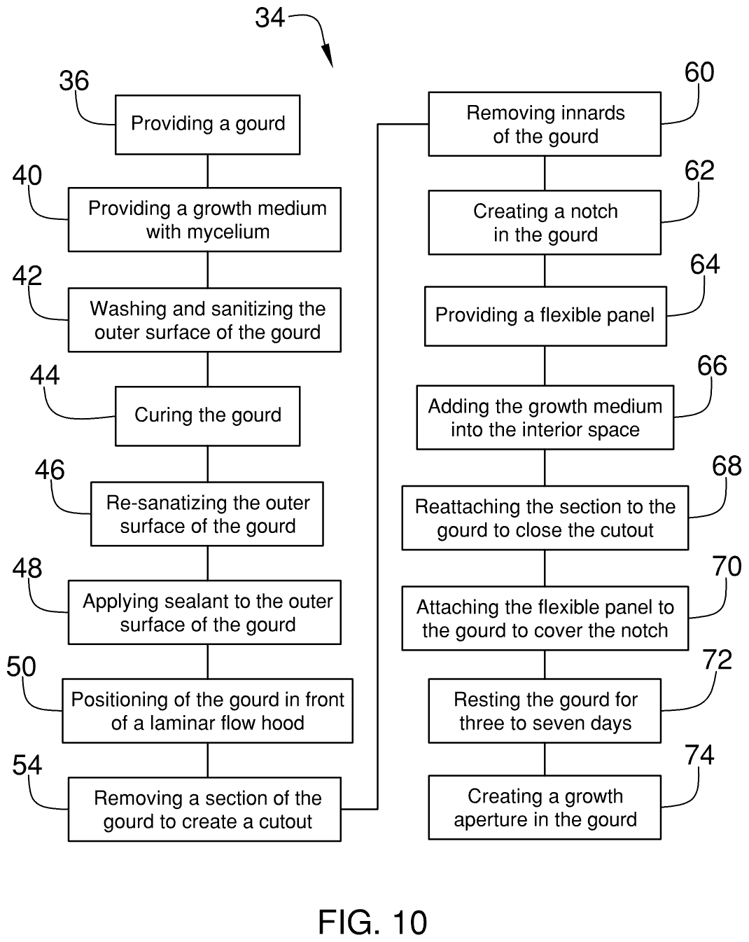

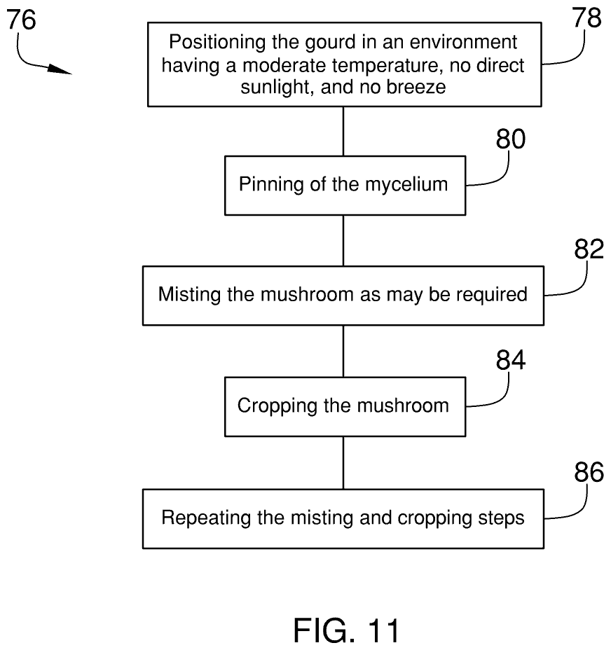

With reference now to the drawings, and in particular to FIGS. 1 through 11 thereof, a new growing kit embodying the principles and concepts of an embodiment of the disclosure and generally designated by the reference numeral 10 will be described.

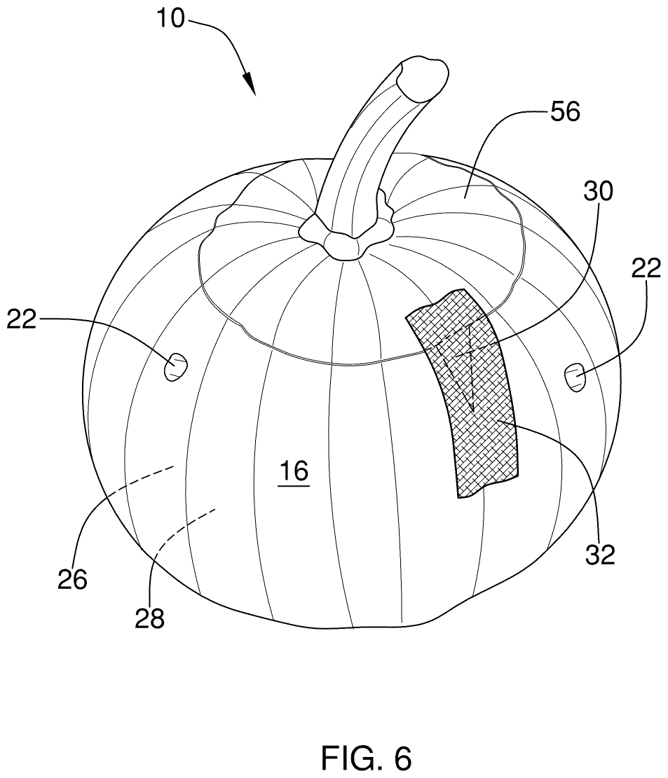

As best illustrated in FIGS. 1 through 11, the mushroom growing system 10 generally comprises a gourd 12 having an inner surface 14 and an outer surface 16 and defining an interior space 18. The outer surface 16 of the gourd 12 may be covered with a sealant 20 to promote shelf life. The gourd 12 is from the genus Cucurbita or the genus Lagenaria. The gourd 12 may be one of Cucurbita argyrosperma, Cucurbita ficifolia, Cucurbita maxima, Cucurbita moschata, Cucurbita pepo, as is shown in FIG. 1, or the like. The gourd 12 has a growth aperture 22 extending therethrough, as is shown in FIG. 6. Typically, the growth aperture 22 is one of a plurality of growth apertures 22 comprising from two to twenty growth apertures 22. As will become apparent, multiple growth apertures 22 allow for growth of a mushroom 24 from each growth aperture 22. The growth aperture 22 has a diameter of from 0.20 to 0.75 inches.

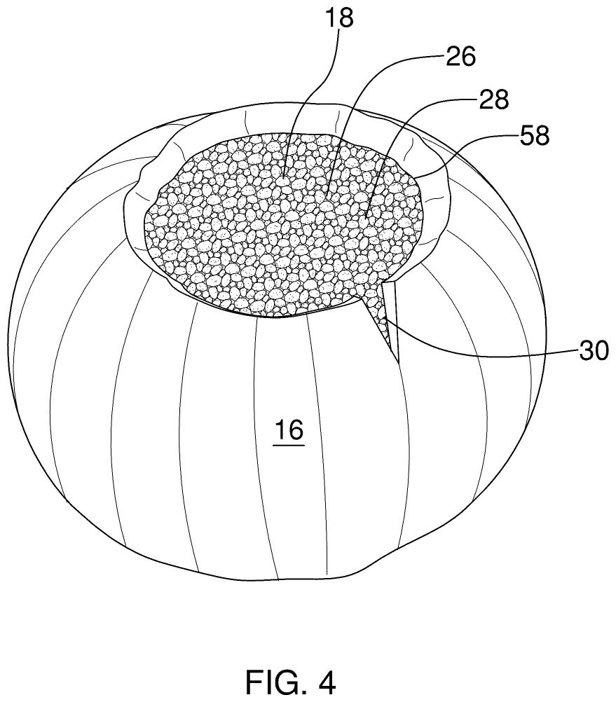

A growth medium 26 is positioned in the interior space 18, as is shown in FIG. 4. The growth medium 26 comprises one or more of wood chips, sawdust, mulched straw, manure, corncobs, paper, coffee pulp, coffee grounds, nut gourds, seed hulls, cottonseed hulls, cocoa bean hulls, cottonseed meal, soybean meal, brewer's spent grain, or the like. The growth medium 26 also may comprise one or both of ammonium nitrate, urea, or the like, as a source of nitrogen to promote growth of the mushroom 24.

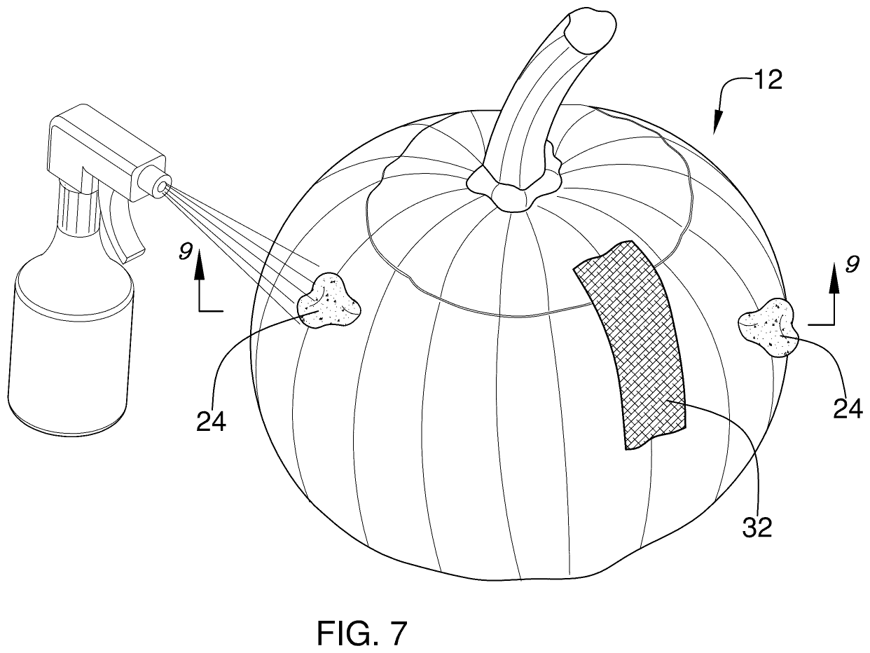

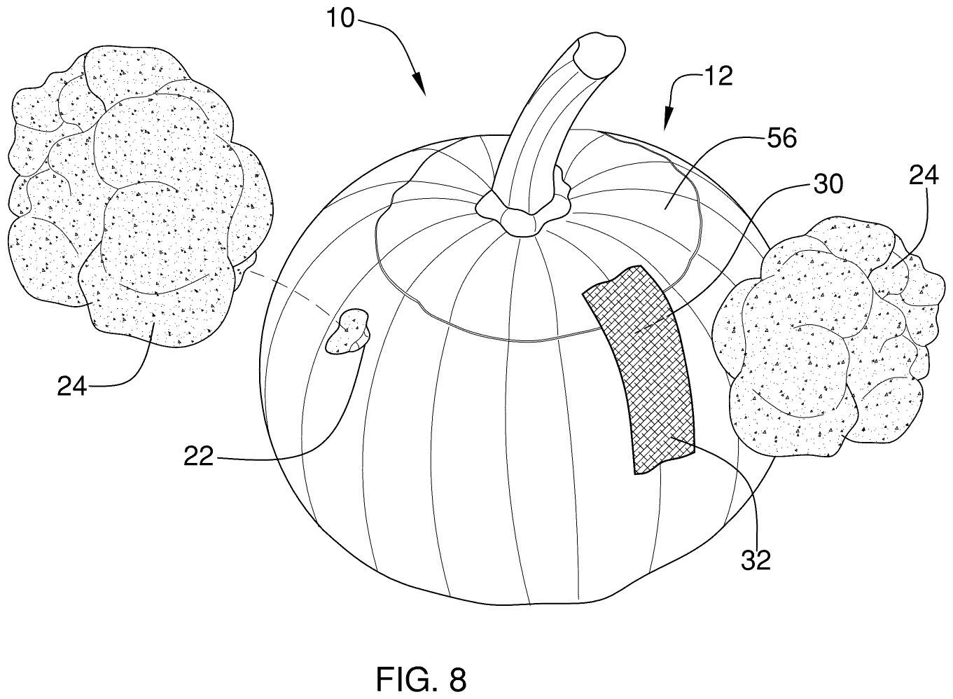

Mycelium 28 are dispersed within the growth medium 26. Pinning of the mycelium 28 causes the mushroom 24 to protrude from the gourd 12 through the growth aperture 22, as is shown in FIG. 7, enabling cropping of the mushroom 24, as is shown in FIG. 8.

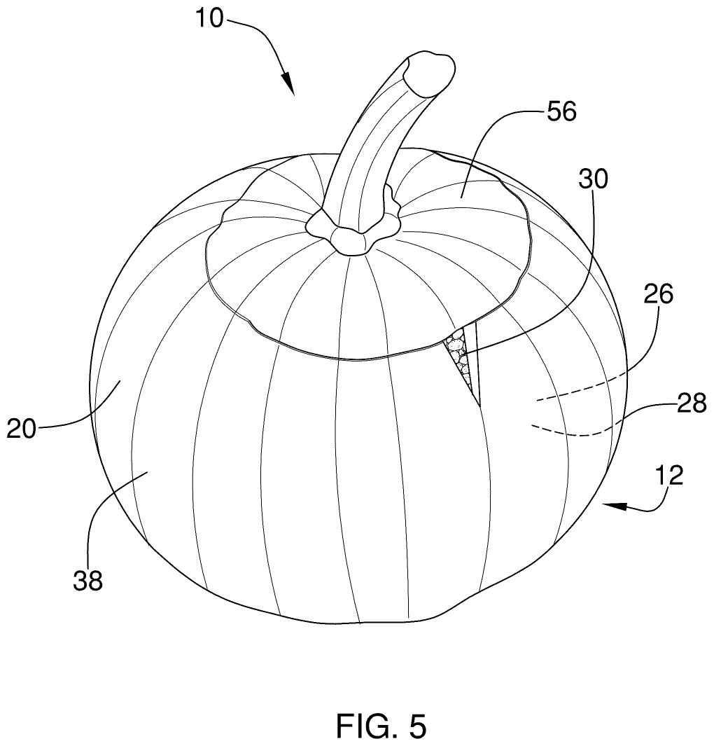

As is shown in FIG. 5, the gourd 12 has a notch 30 extending therethrough. The notch 30 allows for exchange of air between the interior space 18 and the ambient environment. A flexible panel 32 is attached, typically adhesively, to the outer surface 16 of the gourd 12 and covers the notch 30, as is shown in FIG. 6. The flexible panel 32 is microporous and thereby excludes microbes to prevent contamination while still allowing for air exchange. An additional flexible panel 32 could be attached over the growth aperture 22. The flexible panel 32 would detach from the gourd 12 as the mushroom 24 pushes through the growth aperture 22. The present invention anticipates the notch 30 functioning as a growth aperture 22.

A liner, not shown but typically comprised of plastic, may be positioned between the growth medium 26 and the inner surface 14 of the gourd 12. The liner would have a growth hole extending therethrough that is substantially aligned with the growth aperture 22. For some mushroom 24 varieties, the growth medium 26 can be stuffed directly into the gourd 12, while other varieties may require the gourd 12 to be lined before stuffing. The growth medium 26 may be provided in a liner which could be inserted as such into the gourd 12 to line the inner surface 14.

The present invention also anticipates the gourd 12 being provided by a user and the mushroom growing system 10 comprising an instruction for preparation of the gourd 12. In addition to the instruction and the growth medium 26, the mushroom growing system 10 also may include one or more of a flexible panel 32, a liner, an adhesive, a sealant 20, a soap solution, a sanitizing solution, and one or more tools.

Advantages of the mushroom growing system 10 include moisture retention, which may reduce the frequency of misting required for the mushroom 24, and, for some mushroom 24 varieties, the gourd 12 itself serving as an additional food source to sustain growth. The gourd 12 also is more aesthetically pleasing than prior art growing kits for mushrooms 24.

The present invention includes a method of manufacturing a mushroom growing system 34. The manufacturing method 34 comprises a first provision step 36 of providing a gourd 12 defining an interior space 18 and having an inner surface 14 and an outer surface 16. Provision of a fresh gourd 12 without any damage to its skin 38 is important because the gourd 12 optimally will keep for two to three months. A second provision step 40 is providing a growth medium 26 having mycelium 28 dispersed within. A first preparatory step 42 of the manufacturing method 34 is washing and sanitizing the outer surface 16 of the gourd 12, which typically would be performed with a soap solution and a bleach solution, respectively. The first preparatory step 42 is not required but does reduce the risk of contamination.

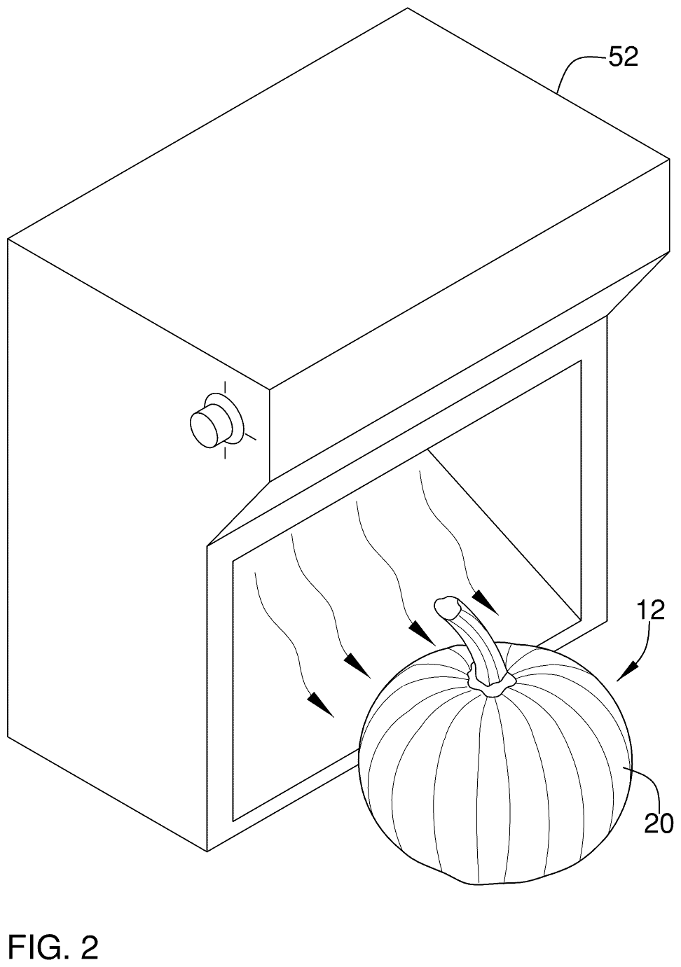

The manufacturing method 34 may include a second preparatory step 44 of curing the gourd 12 for one to four days. Curing is performed by setting the gourd 12 in a warm and humid environment having good air circulation and serves to toughen the skin 38 to extend shelf-life. A third preparatory step 46 then is re-sanitizing the outer surface 16 of the gourd 12. A fourth preparatory step 48 may be included and entails applying a sealant 20 to the outer surface 16 of the gourd 12. This can be accomplished by rubbing the outer surface 16 with a sealant 20, such as mineral oil, coconut oil, or the like, or by spraying the outer surface 16 with a sealant 20, such as a lacquer. The sealant 20 serves to retain moisture in the gourd 12 and to deter contamination. A fifth preparatory step 50 may be included and entails positioning of the gourd 12 in front of a laminar flow hood 52, as is shown in FIG. 2, to reduce further the risk of contamination while completing the following steps.

A first operational step 54 is removing a section 56 of the gourd 12 using a sterile cutting tool (not shown but typically comprising a bladed tool, such as a knife, which has been sterilized with the bleach solution) to create a cutout 58. A second operational step 60 is removing innards (not shown) of the gourd 12 through the cutout 58 using a sterile scooping tool (not shown but which may comprise an ice cream scoop, a melon baller, or the like, which has been sterilized with the bleach solution).

The manufacturing method 34 may include a third operational step 62 of using the sterile cutting tool to create a notch 30 in the gourd 12 that extends from the cutout 58. The manufacturing method 34 then includes a third provision step 64 entailing providing a flexible panel 32, which is microporous. A stuffing step 66 entails addition of the growth medium 26 having mycelium 28 dispersed within into the interior space 18. If the inner surface 14 of the gourd 12 is to be lined, lining is performed prior to the stuffing step 66. An attachment step 68 is reattaching the section 56 to the gourd 12 to close the cutout 58, which typically is performed using an adhesive so that the section 56 is sealably attached, that is in a sealed manner, to the gourd 12.

A fourth operational step 70 is attaching the flexible panel 32, typically adhesively, to the outer surface 16 of the gourd 12 to cover the notch 30. The flexible panel 32 is configured to exclude microbes and to allow for exchange of air between the interior space 18 and the ambient environment. The manufacturing method 34 also may include a rest step 72, which entails resting of the gourd 12 for three to seven days, thereby allowing the mycelium 28 to heal and reconnect. A final step 74 of the manufacturing method 34 is creating a growth aperture 22 in the gourd 12 using a sterile boring tool (not shown, but which may comprise a knife or a drill bit having a width complementary to a desired diameter of the growth aperture 22, or the like, which has been sterilized with the bleach solution).

In use, the mushroom growing system 10 enables a method of growing a mushroom 76, which entails provision of a mushroom growing system 10, as per the specification above. A first step 78 of the growing method 76 is positioning the gourd 12 in an environment having a moderate temperature, no direct sunlight, and no breeze. A second step 80 of the growing method 76 is pinning of the mycelium 28 such that a mushroom 24 protrudes from the gourd 12 through the growth aperture 22. A third step 82 of the growing method 76 is misting the mushroom 24 as may be required depending on relative humidity, as is shown in FIG. 7. A fourth step 84 of the growing method 76 is cropping the mushroom 24 after one to two weeks, or at a time when the mushroom 24 has reached a desired size, as is shown in FIG. 8. A fifth step 86 of the growing method 76 is repeating the misting and cropping steps until the growth medium 26 has been depleted.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A mushroom growing system comprising:
a gourd having an inner surface and an outer surface and defining an interior space, the gourd having a growth aperture positioned therein;
a growth medium positioned in the interior space; and
mycelium being dispersed within the growth medium, wherein pinning of the mycelium causes a mushroom to protrude from the gourd through the growth aperture enabling cropping of the mushroom.

2. The mushroom growing system of claim 1, further including:
the gourd having a notch positioned therein, wherein the notch is configured for exchange of air between the interior space and the ambient environment; and
a flexible panel being attached to the outer surface of the gourd and covering the notch, the flexible panel being microporous, wherein the flexible panel is configured for exclusion of microbes.

3. The mushroom growing system of claim 2, wherein the flexible panel is adhesively attached to the gourd.

4. The mushroom growing system of claim 1, further including a liner being positioned between the growth medium and the inner surface of the gourd, the liner having a growth hole positioned therein, the growth hole being substantially aligned with the growth aperture.

5. The mushroom growing system of claim 4, wherein the liner comprises plastic.

6. The mushroom growing system of claim 1, wherein the gourd is from the genus Cucurbita or the genus Lagenaria.

7. The mushroom growing system of claim 6, wherein the gourd is one of Cucurbita argyrosperma, Cucurbita ficifolia, Cucurbita maxima, Cucurbita moschata, or Cucurbita pepo.

8. The mushroom growing system of claim 1, wherein the growth medium comprises one or more of wood chips, sawdust, mulched straw, manure, corncobs, paper, coffee pulp, coffee grounds, nut gourds, seed hulls, cottonseed hulls, cocoa bean hulls, cottonseed meal, soybean meal, and brewer's spent grain.

9. The mushroom growing system of claim 8, further including the growth medium comprising one or both of ammonium nitrate and urea.

10. The mushroom growing system of claim 1, wherein the growth aperture is one of a plurality of growth apertures, the plurality of growth apertures comprising from one to twenty growth apertures.

11. The mushroom growing system of claim 1, wherein the growth aperture has a diameter of from 0.20 to 0.75 inches.

12. The mushroom growing system of claim 1, further including a sealant covering the outer surface of the gourd.

13. A method of manufacturing a mushroom growing system comprising the steps of:
providing a gourd defining an interior space and having an inner surface and an outer surface;
providing a growth medium having mycelium dispersed within;
washing and sanitizing the outer surface of the gourd;
removing a section of the gourd using a sterile cutting tool to create a cutout;
removing innards of the gourd through the cutout using a sterile scooping tool;
adding the growth medium having mycelium dispersed within to the interior space;
reattaching the section to the gourd to close the cutout; and
creating a growth aperture in the gourd using a sterile boring tool.

14. The manufacturing method of claim 13, further including an additional step of positioning the gourd in front of a laminar flow hood prior to the step of removing the section of the gourd.

15. The manufacturing method of claim 13, further including the additional steps of:
providing a flexible panel, the flexible panel being microporous;
after the step of removing a section of the gourd, using the sterile cutting tool to create a notch in the gourd extending from the cutout; and
after the step of reattaching the section to the gourd to close the cutout, attaching the flexible panel to the outer surface of the gourd to cover the notch, wherein the flexible panel is configured for exclusion of microbes and for exchange of air between the interior space and the ambient environment.

16. The manufacturing method of claim 13, further including, prior to the step of removing the section of the gourd using a sterile cutting tool, the additional steps of:
curing the gourd for one to four days; and
re-sanitizing the outer surface of the gourd.

17. The manufacturing method of claim 13, further including, prior to the step of creating the growth aperture, an additional step of resting the gourd for three to seven days, thereby allowing the mycelium to heal and reconnect.

18. The manufacturing method of claim 13, further including an additional step of applying a sealant to the outer surface of the gourd.

19. The manufacturing method of claim 13, wherein the step of reattaching the section to the gourd to close the cutout is performed using an adhesive such that the section is sealably attached to the gourd.

20. A method of growing a mushroom comprising providing a mushroom growing system manufactured as per claim 13, and:
positioning the gourd in an environment having a moderate temperature, no direct sunlight, and no breeze;
pinning of the mycelium such that a mushroom protrudes from the gourd through the growth aperture;
misting the mushroom as required depending on relative humidity;
cropping the mushroom after one to two weeks; and
repeating the misting and cropping steps until the growth medium is depleted.
